(19) United States
(12) Patent Application Publication
(10) Pub. No.: US 2008/0278084 A1
(43) Pub. Date: Nov. 13, 2008

(54) LED LAMP SET APPARATUS

(76) Inventor: Yuan-Fong CHUNG, Taipei City (TW)

Correspondence Address: SINORICA, LLC, 528 FALLSGROVE DRIVE, ROCKVILLE, MD, 20850, US

(21) Appl. No.: 12/111,507

(22) Filed: Apr. 29, 2008

(30) Foreign Application Priority Data
May 7, 2007 (TW) 096207212

(51) Int. Cl. H05B 37/02

(52) U.S. Cl. 315/207

(57) ABSTRACT

The present invention relates to a LED lamp set apparatus, comprises a gas discharge tube and a LED connected in series, the gas discharge tube is a neon tube, an argon tube, a helium tube or a krypton tube, or a gas tube in which the other inert gases is filled or is filled with a mixture of inert gases. When operating the LED lamp set apparatus provided by the present invention, a public AC power source can be directly input to the LED lamp set apparatus for lighting the LED, needless of an inverter; for protecting the LED, the LED lamp set apparatus can be connected in series with a current-limiting resistance, or the public AC power source can be input to a rectifying diode or a bridge rectifier for processing a rectifying operation and then input to the LED lamp set apparatus; a plurality of the LED lamp set apparatuses can be connected in parallel; or the LED lamp set apparatus can be integratedly-packaged and is inserted to a connector.

### BACKGROUND OF THE INVENTION

1. Field of the Invention

The present invention relates to a LED lighting apparatus, more particularly to a LED lighting apparatus that can be directly lit by public AC power source or can be lit by inputting the public AC power source after being rectified by a rectifying diode or a bridge rectifier without reducing the voltage of the public AC power source.

2. Description of Related Art

For LEDs lit by the public AC power source of 110V or 220V, the public AC power source is often input to an inverter for reducing the voltage thereof then is input to the LEDs after being rectified for lighting the LEDs; or the public AC power source is directly input to a plurality of LEDs connected in series for reducing the voltage applied on each of the LEDs; or the public AC power source is firstly connected in series to high watt resistances then is input to the LEDs; or the public AC power source is directly input to the LEDs by connecting the LEDs and resistances both in series and in parallel for establishing a Wheatstone bridge.

### SUMMARY OF THE INVENTION

If a conventional LED lamp is lit by public AC power source whose voltage is reduced and rectified by an inverter before being input to at least a LED in the LED lamp, more electronic devices are therefore needed and the cost will be raised; if a plurality of LEDs connected in series are lit by directly imputing the public AC power source, without being rectified by an inverter, so as to reduce the voltage applied on each of the LEDs, when one of the LEDs is broken down the whole electrical circuit will be terminated therefore the other LEDs can not be operated; if a means of connecting by more than one parallel circuit and more than one series circuit is adopted, when any of the LEDs provided on any of the series circuit is broken down, the other LEDs provided on the same series circuit can not be operated; if the voltage of the public AC power source is firstly reduced by connecting to resistances both in series or in parallel, then the public AC power source is input to the LEDs for lighting the LEDs, the high-watt resistances will occupy a bigger space, and if the watt-resistance ability thereof is not enough, the resistances will be damaged by the high temperature and may cause danger.

The present invention provides a LED lamp set apparatus, the LED thereof can be lit by directly imputing the public AC power source or can be lit by inputting the public AC power source after being rectified by a rectifying diode or a bridge rectifier without an operation of reducing the voltage of the public AC power source.

For achieving the object mentioned above, the LED lamp set apparatus provided by the present invention characterized in that the LED lamp set apparatus is composed by a gas discharge tube and a LED connected in series. The gas discharge tube is a neon tube, an argon tube, a helium tube or a krypton tube.

A printed circuit board is further provided on the LED lamp set apparatus; one pin of the gas discharge tube passes through the printed circuit board then is connected to one pin of the LED.

A light-pervious plastic member is also provided on the LED lamp set apparatus, the gas discharge tube and the LED are integratedly packaged as one piece by a sealing means provided by the light-pervious plastic member, and one pin of the gas discharge tube and one pin of the LED are exposed outside of the light-pervious plastic member.

A current-limiting resistance is also provided on the LED lamp set apparatus, the gas discharge tube, the LED and the current-limiting resistance are connected in series via a sequence of the gas discharge tube, the LED then the current-limiting resistance or via a sequence of the gas discharge tube, the current-limiting resistance then the LED.

A rectifying diode is further provided on the LED lamp set apparatus, the rectifying diode, the gas discharge tube and the LED are connected in sequence and in series.

The gas discharge tube is connected to the LED in series, then is connected to a bridge rectifier in parallel.

The exposed pins of the gas discharge tube and the LED are connected to a connector.

The features of the present invention are:
1. The LED lamp set apparatus provided by the present invention utilizes a simple and low-cost gas discharge tube for being connected to a LED in series, and the public AC power source can be directly served to light the LED.
2. The current-limiting resistance, the rectifying diode or the bridge rectifier provided for protecting the LED and the gas discharge tube are also simple and low-cost, thus disadvantages of using an inverter that needs more units and welding points and may result in malfunction and unsafety of connecting resistances both in series and in parallel can be avoided; if an integrated and detachable LED lamp set apparatus is adopted, when one of the LED lamp set apparatuses is broken down, the malfunction LED lamp set apparatus can be directly removed and replaced by a new LED lamp set apparatus, so a LED bulb composed by the integrated and detachable LED lamp set apparatus can still be in service rather than throwing away.

### BRIEF DESCRIPTION OF THE DRAWINGS

FIG. 1 is a 3D view of the LED lamp set apparatus provided by the present invention being disposed on a printed circuit board;

FIG. 2 is a 3D view of the LED lamp set apparatus provided with a current-limiting resistance then being disposed on a printed circuit board;

FIG. 3 is a 3D view of the LED lamp set apparatus being integratedly packaged;

FIG. 4 is 3D view of the LED lamp set apparatus packaged in with a SMD (Surface Mounting Device) fashion;

FIG. 5 is a 3D exploded view of the LED lamp set apparatus being assembled for forming a LED bulb;

FIG. 6 is a 3D view of the assembled LED bulb;

FIG. 7 is a 3D exploded view of the integratedly-packaged LED lamp set apparatus being connected to a connector and being assembled for forming a LED bulb;

FIG. 8 is a 3D view of the integratedly-packaged LED lamp set apparatus being connected to a connector and being assembled for forming a LED bulb;

FIG. 9 is a 3D view of the LED bulb consisting of a plurality of LED lamp set apparatuses connected in parallel;

FIG. 10 is 3D view of the LED bulb consisting of a plurality of the integratedly-packaged LED lamp set apparatuses connected in parallel and is provided with a connector;

FIG. 11 is a basic circuit diagram of the LED lamp set apparatus provided by the present invention;

FIG. 12 is a basic circuit diagram of the LED of the LED lamp set apparatus provided by the present invention being inversely utilized;

FIG. 13 is a circuit diagram of the LED lamp set apparatus provided by the present invention being provided with a current-limiting resistance;

FIG. 14 a circuit diagram of the LED of the LED lamp set apparatus provided by the present invention being inversely utilized and being provided with a current-limiting resistance;

FIG. 15 a circuit diagram of the LED lamp set apparatus provided by the present invention being provided with a rectifying diode and being processed with a half-wave rectifying operation;

FIG. 16 is a circuit diagram of the LED lamp set apparatus provided by the present invention being provided with two rectifying diodes and being processed with a full-wave rectifying operation;

FIG. 17 is a circuit diagram of the LED lamp set apparatus provided by the present invention being provided with a current-limiting resistance and a rectifying diode and being processed with a half-wave rectifying operation;

FIG. 18 is a circuit diagram of the LED lamp set apparatus provided by the present invention being provided with a current-limiting resistance and two rectifying diodes and being processed with a full-wave rectifying operation;

FIG. 19 is a circuit diagram of the LED lamp set apparatus provided by the present invention being provided with a bridge rectifier;

FIG. 20 is a circuit diagram of the LED lamp set apparatus provided by the present invention being provided with a current-limiting resistance and a bridge rectifier;

FIG. 21 is a circuit diagram of the LED lamp set apparatus provided by the present invention being provided with current-limiting resistances and operated in parallel;

FIG. 22 is a circuit diagram of the LED lamp set apparatus provided by the present invention being provided with current-limiting resistances and a rectifying diode and is operated in parallel after being processed with a half-wave rectifying operation;

FIG. 23 is a circuit diagram of the LED lamp set apparatus provided by the present invention being provided with current-limiting resistances and two rectifying diodes and is operated in parallel after being processed with a full-wave rectifying operation;

FIG. 24 is a circuit diagram of the LED lamp set apparatus provided by the present invention being provided with current-limiting resistances and a bridge rectifier and is operated in parallel after being processed with a full-wave rectifying operation.

### DETAILED DESCRIPTION OF THE PREFERRED EMBODIMENT

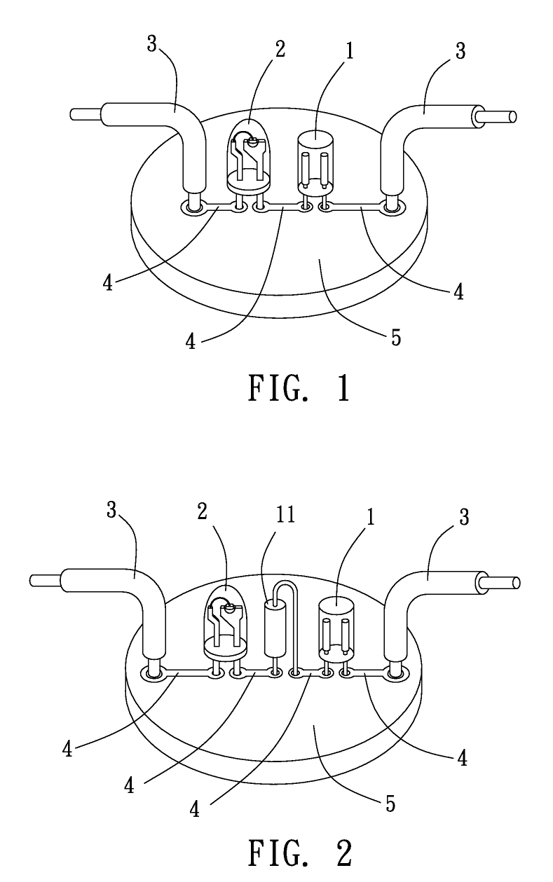

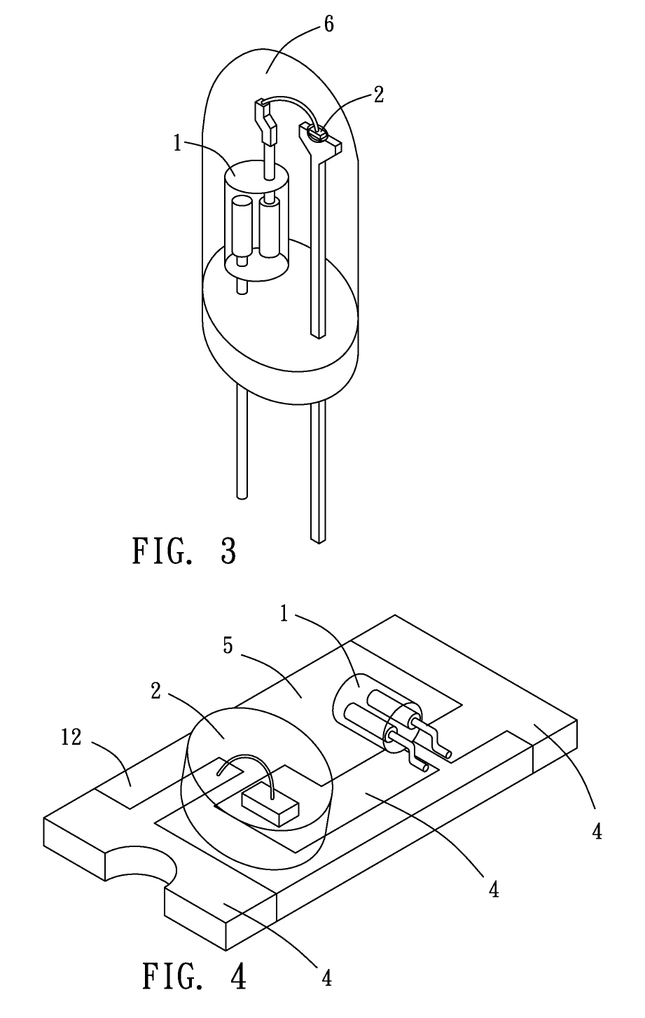

The first embodiment of the present invention please refers to FIG. 1, FIG. 11 and FIG. 12, the LED lamp set apparatus provided by the present invention is composed by a gas discharge tube 1 and a LED 2 that are connected in series. The gas discharge tube 1 is a neon tube, an argon tube, a helium tube or a krypton tube, or a gas discharge tube in which the filled inert gas is capable of voltage discharging or a gas tube with mixed insert gases; an external public AC power source 13 is directly connected to the LED lamp set apparatus via power wires 3 for lighting the LED. Referring to FIG. 4, for a purpose of massive production, the gas discharge tube 1 and the LED 2 are welded on a carrying plate 12 having connecting wires 4, and are packaged with a SMD (Surface Mounting Device) fashion; so during the massive production, a machine adopted a SMT (Surface Mounting Technology) means can be served to assemble the LED lamp set apparatus on related applications of LED lamps. When assembling the LED, the polarity of the LED can be not in considerations, in other words one of the pins of the gas discharge tube can be connected the positive electrode of the LED or can be connected to the negative electrode of the LED.

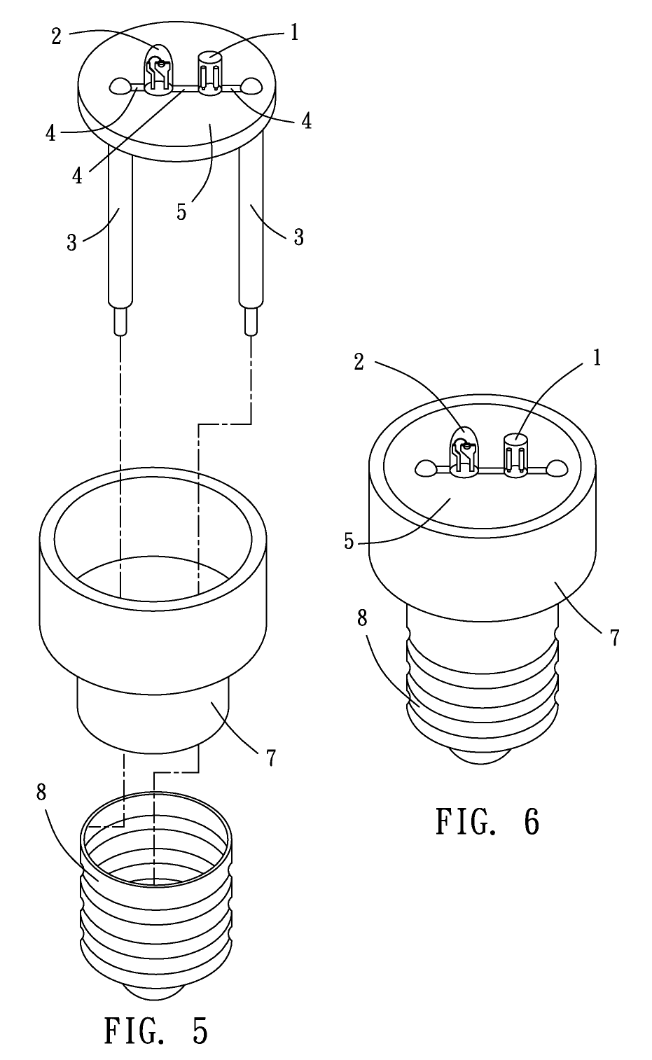

In the second embodiment of the present invention, the LED lamp set apparatus is further provided with a printed circuit board 5; one of the pins of the gas discharge tube 1 is passed through one of the connecting wires 4 of the printed circuit board 5 and is connected to one of the pins of the LED; the other pin of the gas discharge tube 1 and the other pin of the LED 2 are respectively passed through the connecting wires of the printed circuit board and are respectively connected to the power wires 3; the external public AC power source 13 is directly connected the LED lamp set apparatus via the power wires 3 for lighting the LED. Referring to FIG. 5 and FIG. 6, the LED lamp set apparatus as shown in FIG. 1 is provided with a bulb head 8 and a retaining bulb tube 7 and the two power wires 3 are respectively connected to the two electrodes of the bulb head 8 so as to form a LED bulb.

The third embodiment of the present invention please refers to FIG. 3, the LED lamp set apparatus is further provided with a light-pervious plastic member 6, one of the two pins of the gas discharge tube 1 and one of the two pins of the LED 2 are connected in series via a fashion of welding or reeling, the gas discharge tube 1 and the LED 2 are integratedly packaged by a sealing means provided by the light-pervious plastic member 6, and one of the two pins of the gas discharge tube 1 and one of the two pins of the LED 2 are exposed outside of the light-pervious plastic member 6 for being connected to the power wires.

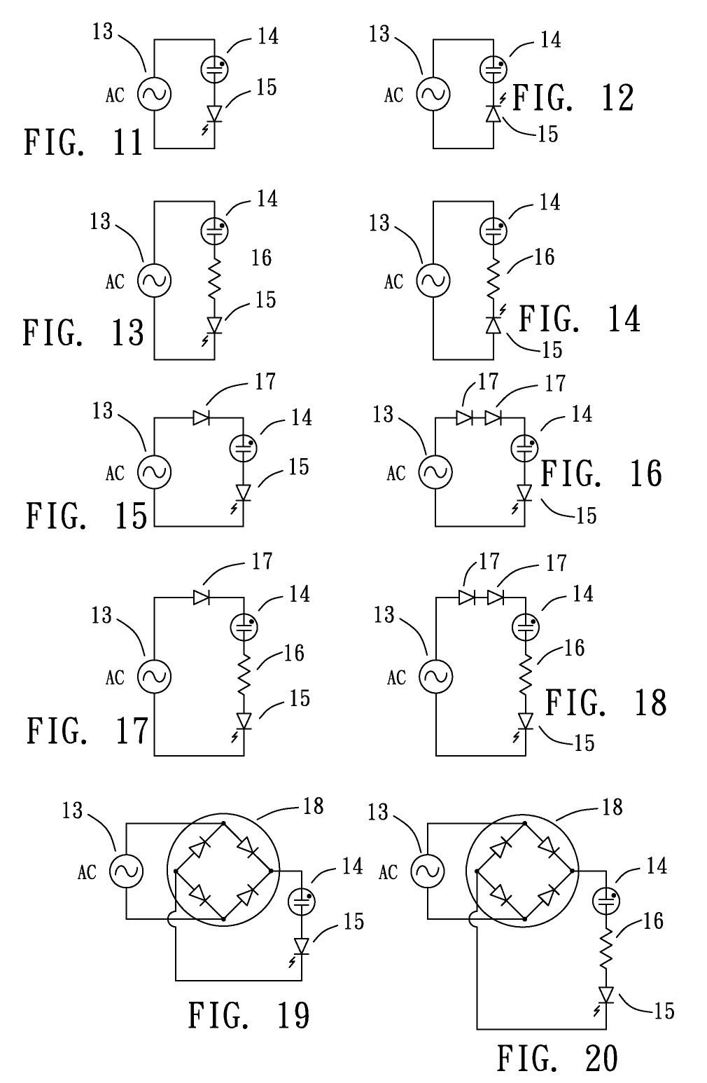

The fourth embodiment of the present invention please refers to FIG. 2, FIG. 13 and FIG. 14, for extending the service life of the LED, the LED lamp set apparatus is further provided with a current-limiting resistance 11 (or 16), wherein the current-limiting resistance 11 (or 16) is connected in series between the gas discharge tube 1 and the LED 2 (or 15); and the gas discharge tube 1, the LED 2 and the current-limiting resistance 11 (or 16) are connected in series via a sequence of the gas discharge tube 1, the LED 2 then the current-limiting resistance 11 (or 16) or via a sequence of the gas discharge tube 1, the current-limiting resistance 11 (or 16) then the LED 2, so the direction of the LED 2 is not limited. The resistance ability of the current-limiting resistance 11 (or 16) is according to the voltage input by the public AC power source and the maximum sustaining current of the LED.

The fifth embodiment of the present invention please refers to FIG. 15 and FIG. 16, for preventing the LED form being burn by an overly-high instantaneous inverse voltage, the gas discharge tube 14 and the LED 15 provided by the present invention are connected in series to one or two rectifying units 17, e.g. a rectifying diode, then are connected to a public AC power source, in other words the public AC power source is firstly processed with a half-wave DC rectifying operation or a full-wave rectifying operation then is input to the gas discharge tube 14 and the LED 15, thus the output positive electrode of the power source after being rectified has to be connected to the positive electrode of the LED, the output negative electrode of the power source after being rectified has to be connected to the negative electrode of the LED.

Referring to FIG. 17 and FIG. 18, the gas discharge tube 14, the LED 15, the rectifying unit 17 and the current-limiting resistance 16 are connected together in series then are connected to the public AC power source 13.

Referring to FIG. 19 and FIG. 20, the gas discharge tube 14 and the LED 15 provided by the present invention are connected in series with a rectifying unit 18, e.g. a bridge rectifier, then connected to the public AC power source so the public AC power source is processed with a full-wave DC rectifying operation then is input to the LED lamp set apparatus, thus the output positive electrode of the power source after being rectified has to be connected to the positive electrode of the LED, the output negative electrode of the power source after being rectified has to be connected to the negative electrode of the LED.

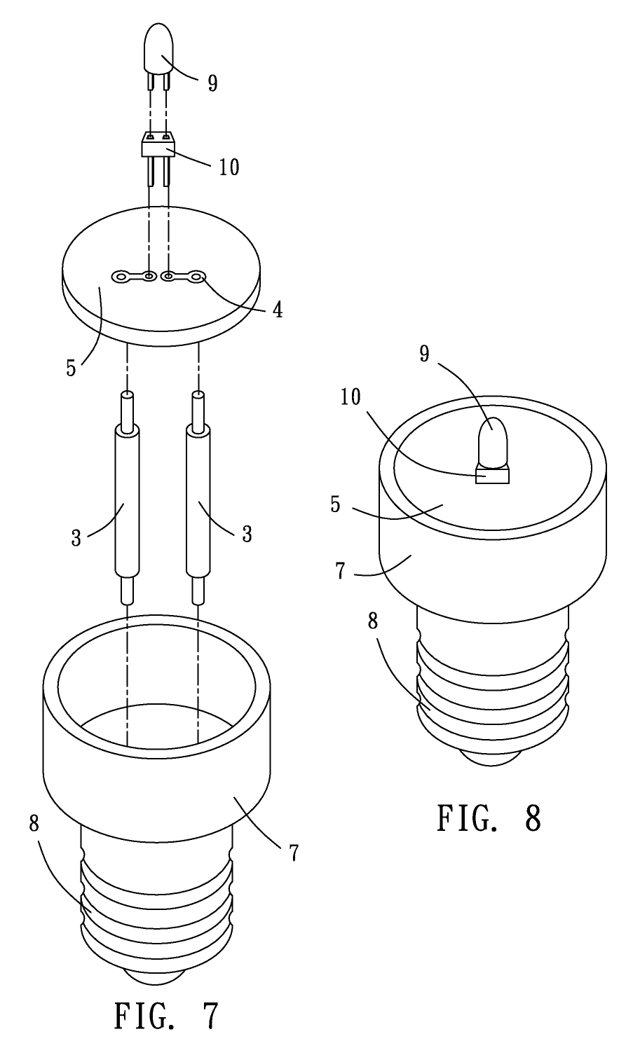

Referring to FIG. 7, the exposed pins of the gas discharge tube 1 and the LED 2 of the integratedly-packaged LED lamp set apparatus 9 as shown in FIG. 3 are connected to a connector 10, then is combined with the bulb head 8 and the retaining bulb tube 7, and the two power wires 3 provided on the printed circuit board 5 are respectively connected to the two electrodes of the bulb head 8 so as to form a LED bulb as shown in FIG. 8, wherein the connector 10 is provided on the printed circuit board 5, the integratedly-packaged LED lamp set apparatus 9 is needless of a welding operation, and can be directly connected to the connector 10, if the LED lamp set apparatus 9 is not connected to the connector 10 then the LED lamp set apparatus 9 can also be welded onto the connecting wires 4 of the printed circuit board 5.

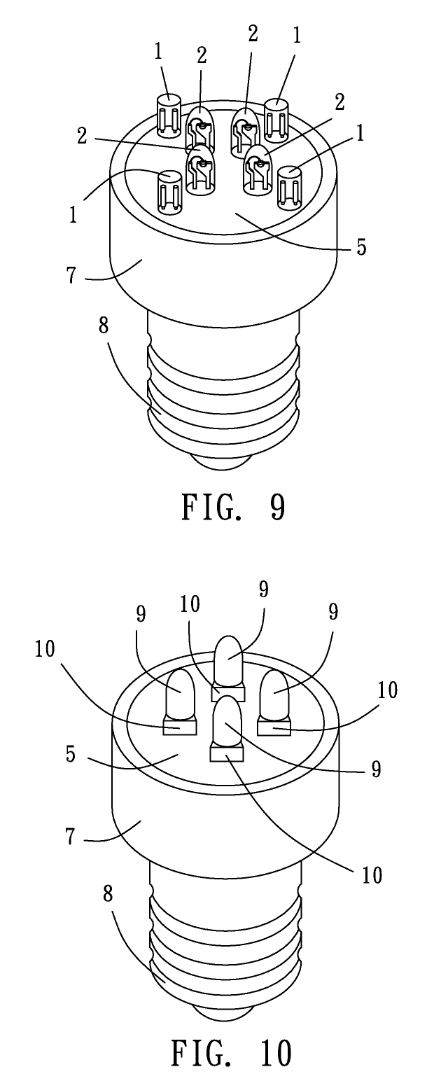

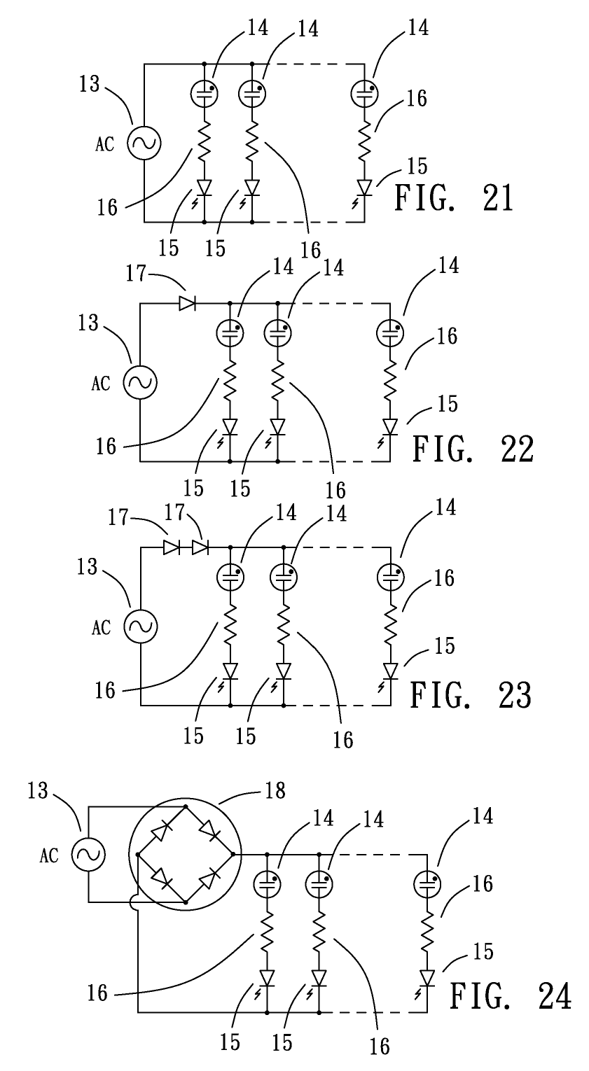

Referring to FIG.9, FIG. 10, FIG. 21, FIG. 22, FIG. 23 and FIG. 24, in order to increase the illumination of the LED bulb, a plurality of the LED lamp set apparatuses can be connected in parallel within the same LED bulb. When one of the LED lamp set apparatuses is broken down, the broken one can be directly removed and a new LED lamp set apparatus can be served for replacement, so the LED bulb can be remained in service rather than being thrown away; if the broken LED lamp set apparatus is removed without a new LED lamp set apparatus for replacement, the LED bulb can still be in service with the other LED lamp set apparatuses.

The gas discharge tube provided by the present invention is served to work with the public AC power source, in other words the public AC power source of 110V can be connected to the gas discharge tube of 110V or 200V, but the public AC power source of 200V can only be connected to the gas discharge tube of 200V, can not be connected to the gas discharge tube of 110V or the gas discharge tube and the LED will be burn and damaged; in the same public AC power source, the illumination of the LED lamp set apparatus is in a positive relationship with the metal area of the gas discharge tube, in other words the larger the discharging metal area of the gas discharge tube, the bigger current passing through the gas discharge tube, thus the illumination of the LED lamp set apparatus is brighter; the gas discharge tube used in the LED lamp set apparatus is adopted because of the current generated by gas discharging in a high voltage, so inert gases of helium, neon, argon or krypton, or other gases which can generate electrical ions can be selected.

What is claimed is:

1. A LED lamp set apparatus, comprises:
a rectifying unit;
a gas discharge tube connected in series with the rectifying unit;
a LED connected in series with the gas discharge tube; and
a current-limiting resistance connected in series with the LED;
one pin of the rectifying unit and one pin of the current-limiting resistance are exposed outside for being connected to a public power source.

2. The LED lamp set apparatus as claimed in claim 1, wherein the gas discharge tube is a neon tube, an argon tube, a helium tube or a krypton tube, or a gas tube in which the other inert gases is filled or is filled with a mixture of inert gases.

3. The LED lamp set apparatus as claimed in claim 1, wherein the rectifying unit is a rectifying diode or a bridge rectifier; the gas discharge tube is connected in series with the LED and the current-limiting resistance then connected in series with the rectifying diode or connected in parallel with the bridge rectifier.

4. The LED lamp set apparatus as claimed in claim 1, wherein the LED lamp set apparatus is further provided with a printed circuit board, the rectifying unit, the gas discharge tube, the LED and the current-limiting resistance are connected via connecting wires provided on the printed circuit board, and two power wires are provided on the printed circuit board.

5. The LED lamp set apparatus as claimed in claim 1, wherein, the LED lamp set apparatus is further provided with a retaining bulb tube for receiving the printed circuit board and the rectifying unit, the gas discharge tube, the LED and the current-limiting resistance disposed on the printed circuit board; and a bulb head for receiving the retaining bulb tube, two electrodes of the bulb head are respectively connected to the two power wires of the printed circuit board so as to form a LED bulb.

6. The LED lamp set apparatus as claimed in claim 4, wherein, the LED lamp set apparatus is further provided with a retaining bulb tube for receiving the printed circuit board and the rectifying unit, the gas discharge tube, the LED and the current-limiting resistance disposed on the printed circuit board; and a bulb head for receiving the retaining bulb tube, two electrodes of the bulb head are respectively connected to the two power wires of the printed circuit board so as to form a LED bulb.
